(19) United States
(12) Patent Application Publication
(10) Pub. No.: US 2013/0117196 A1
(43) Pub. Date: May 9, 2013

(54) CONTRACT COMPLIANCE SYSTEM

(71) Applicant: Ari Fuad, Eden Prairie, MN (US)

(72) Inventor: Ari Fuad, Eden Prairie, MN (US)

(21) Appl. No.: 13/288,602

(22) Filed: Nov. 3, 2011

(51) Int. Cl. G06Q 40/06; G06Q 99/00

(52) U.S. Cl. 705/36 R; 705/317

(57) ABSTRACT

Disclosed is a system and method for monitoring compliance with contract criteria. A rule-tracking module is configured to receive a document comprising client-specified criteria; deconstruct the criteria into contract rules and store the contract rules on the data storage component; and associate with each of the contract rules the document comprising the criteria from which such rule derives. A rule-monitoring module is configured to assign a risk level to each of the rules based on a subjective importance of such rule. A rule testing module is configured to receive information regarding the testing of rules and provide a notification if a rule has not been tested within the testing time period of such rule.

### TECHNICAL FIELD OF THE DISCLOSURE

The present disclosure is generally directed to a system and method for governance, risk management, and compliance (GRC).

### BACKGROUND

Contracts are comprised of one or more contract terms, or contract criteria, to which the parties to the contract agree to be bound. In other words, contracts define a series of rules or guidelines that govern the parties' performance. The contract criteria may be updated by the parties over time. Some contract terms prescribe allowable and/or prohibited behaviors; other terms require periodic actions to be taken or can dictate actions that are triggered upon the occurrence of defined events. Contract rules and guidelines may be used a party to the contract charged with performance to develop compliance rules against which decisions and actions concerning the contract are analyzed.

Compliance rules, whether related to back-end or front-end compliance, have been used by parties to a contract in computerized rule-testing management systems. In the past, compliance rules have been translated into computer readable statements. Such statements are then used to instruct a computer system to monitor decisions regarding the contract, and to inform the party charged with performance whether particular decisions involving the contract are in compliance with the criteria set forth in the contract. Such monitoring may occur at specified intervals, such as daily, weekly, monthly, etc.

Not all rules and guidelines lend themselves to automatic checking by computerized systems. Such rules end up requiring ad-hoc manual systems that can be complicated and labor intensive. Systematic capturing the results of such processes can substantially improve the auditability of performance against the contract guidelines and restrictions.

One particular area where contract management systems have been employed is the investment management business. Investment managers, and in particular, those who are responsible for managing the portfolios of large institutional investors, buy and sell fixed income securities, equities, and other investment instruments based upon the criteria set forth by the investors. Investment criteria may include one or more objectives, restrictions, allocations, guidelines, and the like. For example, a particular institutional investor may wish to restrict certain types of assets from its portfolio. In such an instance, the investor may instruct its portfolio manager not to purchase corporate bonds, equities, or other investment instruments from certain corporations or industry sectors. Alternatively, a particular institutional investor may have the desire to limit a certain percentage of its assets under management to certain types of fixed income securities. For example, an institutional investor may designate that not more than five percent of its assets under management should be invested in commercial mortgage backed securities (CMBS). In a further example, the investor may be subject to one or more regulations imposed by an investment regulator that the institutional investor must follow.

Other areas where contract management systems may be employed include, but are not limited to, the medical device industry, supply contracts for all types of manufacturing, apartment management, and all types of outsourcing contracts, among others.

In many instances where contracts are in force, one or more of the parties to the contract lack an effective means to monitor the performance of the other parties, such as the other parties' compliance with the stated criteria, other than reviewing monthly or quarterly statements that may be received, for example, in the case of an investment management contract. For example, in this case, one party to the contract, the investor, would have no way to determine on a regular basis whether or not required compliance checks are being completed in a timely manner. Furthermore, the investor has no way to audit the performance of the investment manager against the stated criteria.

Presently lacking in the art are systems and methods for comprehensive auditing of contract compliance. In particular, it would be beneficial to provide a system and method to standardize and track contract performance criteria. It would further be beneficial to provide a system and method to monitor the compliance of the party charged with performance of the contract with the stated criteria.

### BRIEF SUMMARY OF THE DISCLOSURE

In one embodiment, disclosed herein is a computer-implemented method of monitoring contract compliance criteria, that may include receiving a document comprising one or more client-specified criteria related to a contract; deconstructing the criteria into one or more contract rules; storing the one or more contract rules in a database operatively connected with a computer processor; and associating with each of the one or more stored contract rules the document comprising the criteria from which such rule derives.

Variations of this embodiment may include associating with each of the one or more stored contract rules an indication of the client to which such rule pertains. The criteria may be deconstructed into two or more rules, and wherein at least two of the two or more rules are grouped into a function. The rules may be grouped based on similarity.

Further variations of this embodiment may include assigning a risk level to each of the one or more rules based on a subjective importance of such rule. The risk level may be selected from the group consisting of “high”, “medium”, and “low”. A risk level may be associated with the criteria, and wherein the risk level assigned to each rule corresponds with the risk level of the criteria from which such rule derives. Further, the method may include assigning a risk level to a function based on the individual risk level of each of the two or more rules that comprise the function.

In another embodiment, disclosed herein is a computer-implemented method of monitoring compliance with contract criteria, which may include receiving a document comprising one or more client-specified criteria related to an contract; deconstructing the criteria into one or more contract rules, wherein each of the rules comprises a testing time period; receiving electronic information from a computerized contract management system regarding the testing of rules against the actual performance of the contract; and providing a notification if a rule has not been tested within the testing time period of such rule.

In variations of this embodiment, the criteria may be deconstructed into two or more rules. The method may further include assigning a risk level to each of the one or more rules based on a subjective importance of such rule. At least two of the two or more rules may be grouped into a function. The method may further include assigning a risk level to a function based on the individual risk level of each of the two or more rules that comprise the function. Further, rules in a function with a relatively higher risk level may be tested against the performance of the contract prior to rules in a function with a relatively lower risk level. In a further extension, functions will aggregate the current market value of all the portfolios associated with the function via their related rules. This aggregate value may be used to identify the relative impact of a missed test or failure to perform on the client mandates associated with the function.

In yet another embodiment, disclosed herein is a computer-based system for monitoring compliance with contract criteria, which may include a data processing component and a data storage component in electronic communication with one another; a rule tracking module configured to cause the data processing component to receive a document comprising one or more client-specified contract criteria; deconstruct the criteria into one or more contract rules and store the contract rules on the data storage component; and associate with each of the one or more contract rules the document comprising the criteria from which such rule derives; a rule priority module configured to cause the data processing component to assign a risk level to each of the one or more rules based on a subjective importance of such rule; and a rule testing module configured to cause the data processing component to receive electronic information from a computerized management system regarding the testing of rules against the performance of the contract and provide a notification if a rule has not been tested within the testing time period of such rule.

In variations of this embodiment, the contract criteria may be deconstructed into two or more rules, wherein at least two of the two or more rules are grouped into a function. The rule priority module may be configured to assign a risk level to a function based on the individual risk level of each of the two or more rules that comprise the function. Further, rules in a function with a relatively higher risk level may be tested prior to rules in a function with a relatively lower risk level.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 depicts a computer-implemented system suitable for use with embodiments of the present disclosure;

FIG. 2 is a block diagram depicting a client interface in accordance with one embodiment of the present disclosure;

FIG. 3 depicts an example client screen view in accordance with one embodiment of the present disclosure;

FIG. 4 depicts an example portfolio screen view in accordance with one embodiment of the present disclosure;

FIG. 5 depicts an example function listing screen view in accordance with one embodiment of the present disclosure;

FIG. 6 depicts an example function editing screen view in accordance with one embodiment of the present disclosure;

FIG. 7 depicts a block diagram illustrating a method in accordance with one embodiment of the present disclosure;

FIG. 8 depicts a block diagram illustrating a further method in accordance with one embodiment of the present disclosure;

FIG. 9 depicts a block diagram illustrating yet a further method in accordance with one embodiment of the present disclosure;

FIG. 10a depicts an example rules listing screen view in accordance with one embodiment of the present disclosure; and

FIG. 10b depicts an example rules detail screen view in accordance with one embodiment of the present disclosure.

### DETAILED DESCRIPTION

The presently described system and method, in one embodiment, may provide comprehensive monitoring and auditing of the performance of contracts. A system as used herein may include any electronically implemented system that facilitates the implementation of contract management criteria. Existing management systems typically include one or more rules databases, where the various contract rules are stored, and one or more processors operable to “test” the contract rules. Where the processor of the computerized system detects that a particular act or course of performance violates one of the portfolio specific rules in the database, a warning may be issued to the appropriate party to the contract. While, in one embodiment, such functions may be performed automatically by the system, it will be appreciated that any of the contract management functions described herein may be accomplished manually, or manually with the assistance of a computerized system.

One example where contract management according to the present disclosure may be employed is investment contract management, for example, investment contract management that employs computerized portfolio management system. Existing computerized portfolio management systems, however, suffer from several drawbacks. For example, computerized portfolio management systems are typically very complicated to use and generally fail to efficiently log all changes to the system. Consequently, errors in configuration and configuration “Decay” can cause errors and deviations that cause required tests to not be performed. In another example, computerized portfolio management systems typically have no effective means to track each of the investment criteria specified by the investor, including any updates or modifications to such criteria as may occur over time. Typically, investment criteria are translated into the computerized system in the form of one or more computer-readable rules. Such rules are typically entered and updated on an as-needed basis by a human operator, and as such are difficult to track and ensure the accuracy thereof.

Embodiments of the present disclosure include features that overcome the aforementioned limitations known in the art. For example, embodiments of the present disclosure, as will be discussed in greater detail below, may include a rule-tracking module that may capture contract criteria and maintain an accurate record of the origin and implementation of such criteria. In another example, embodiments of the present disclosure, as will be discussed in greater detail below, may include a rule priority module that may assign a relative importance level to the one or more contract rules to efficiently distinguish between rules of relatively higher importance and rules of relatively lower importance. In yet another example, embodiments of the present disclosure, as will be discussed in greater detail below, may include a rule testing module that may monitor the performance of the system to ensure that all of the required tests are being performed at the required times. The systems of the present disclosure may include a computer-implemented system providing an electronic interface so as to allow one or more parties to the contract to continuously monitor the performance of the system, to track contract rules, and to ensure that all required tests are being performed. As such, the systems and methods of the present disclosure may provide comprehensive auditing for contracts.

### Computer-Implemented System

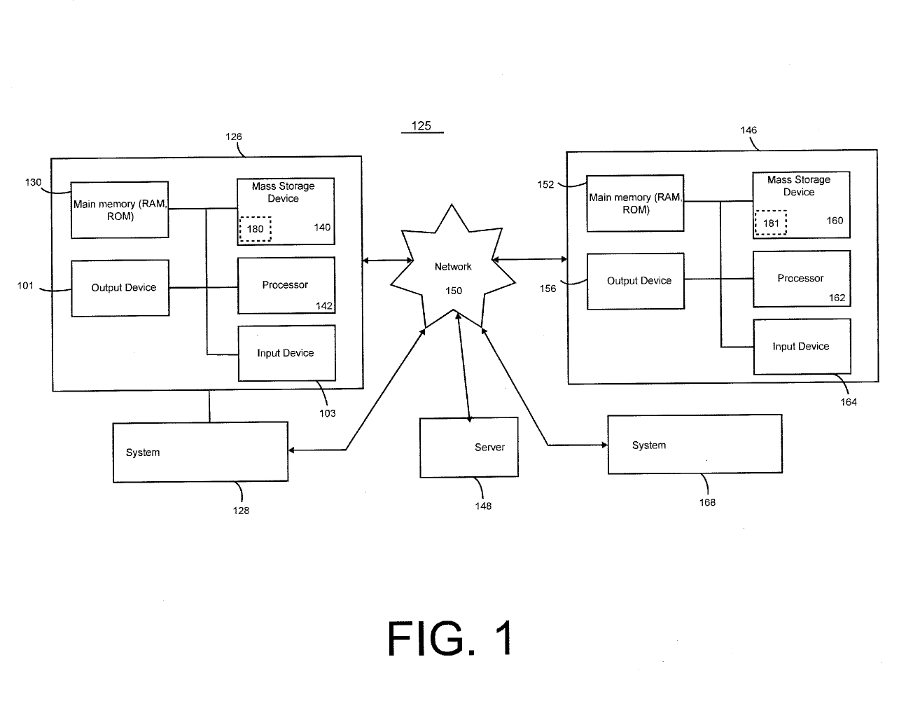

Embodiments of the present disclosure may be implemented through one or more computing devices connected with one another through an electronic network. As shown particularly in FIG. 1, a computing device used with the present disclosure may be part of a larger network system 125 of devices. System 125 may include one or more computing devices 126 connected with a network 150, such as a local area network (LAN) or the Internet. Computing device 126 can interact with a server 146 in order to input and receive information, for example but not limited to, contract criteria, testing information, and notification information. Computing devices as used herein are not limited to traditional personal computers, but may also include laptops, PDAs, Smartphones, tablet computers, and the like.

System 125 may also include the ability to access one or more website servers 148 in order to obtain content from the Internet for use with the contract auditing systems and methods described herein. While only one computing device is shown for illustrative purposes, system 125 may include a plurality of computing devices 126 and may be scalable to add or remove computing devices to or from a network. System 125 may also include the ability to access and interface with one or more computerized contract management systems 128, 168 via network 150 or by a direct electronic connection thereto.

Computing device 126 illustrates components of an embodiment of a suitable computing device for use with the present disclosure. Computing device 126 may include a main memory 130, one or more mass storage devices 140, a processor 142, one or more input devices 103, and one or more output devices 101. Main memory 130 may include random access memory (RAM), read-only memory (ROM), or similar types of memory. One or more programs or applications 180, such as a web browser, and/or other applications may be stored in one or more data storage devices 140. Data storage devices 140 may further include a database for storing contract criteria, rules, and rule tracking information, among other things. Programs or applications 180 may be loaded in part or in whole into main memory 130 or processor 142 during execution by processor 142. Mass storage device 140 may include, but is not limited to, a hard disk drive, floppy disk drive, CD-ROM drive, smart drive, flash drive, or other types of non-volatile data storage, a plurality of storage devices, or any combination of storage devices. Processor 142 may execute applications or programs to run systems or methods of the present disclosure, or portions thereof, stored as executable programs or program code in memory 130 or mass storage device 140, or received from the Internet or other network 150. Input interface 103 may include any device for entering information into computing device 126, such as but not limited to, a microphone, digital camera, video recorder or camcorder, keys, keyboard, mouse, cursor-control device, touch-tone telephone or touch-screen, a plurality of input devices, or any combination of input devices. Output device 101 may include any type of device for presenting information to a user, including but not limited to, a computer monitor or flat-screen display, a printer, and speakers or any device for providing information in audio form, such as a telephone, a plurality of output devices, or any combination of output devices.

A server 146, for example located remotely from the computing device 126, may also be connected to the network 150. Server 146 may include a main memory 152, one or more mass storage devices 160, a processor 162, one or more input devices 164, and one or more output devices 156. Main memory 152 may include random access memory (RAM), read-only memory (ROM), or similar types of memory. One or more programs or applications 181, such as a web browser and/or other applications, may be stored in one or more mass storage devices 160. Programs or applications 181 may be loaded in part or in whole into main memory 152 or processor 162 during execution by processor 162. Mass storage device 160 may include, but is not limited to, a hard disk drive, floppy disk drive, CD-ROM drive, smart drive, flash drive or other types of non-volatile data storage, a plurality of storage devices, or any combination of storage devices. Processor 162 may execute applications or programs to run systems or methods of the present disclosure, or portions thereof, stored as executable programs or program code in memory 152 or mass storage device 160, or received from the Internet or other network 150. Input device 164 may include any device for entering information into server 146, such as but not limited to, a microphone, digital camera, video recorder or camcorder, keys, keyboard, mouse, cursor-control device, touch-tone telephone or touch-screen, a plurality of input devices, or any combination of input devices. Output device 156 may include any type of device for presenting information to a user, including but not limited to, a computer monitor or flat-screen display, a printer, or speakers or any device for providing information in audio form, such as a telephone, a plurality of output devices, or any combination of output devices.

Server 146 may store a database structure in mass storage device 160, for example, for storing contract criteria, rules, and rule tracking information, among other things. Any type of data structure can be used, such as a relational database or an object-oriented database.

Processors 142, 162 may, alone or in combination, execute one or more applications 180, 181 in order to provide some or all of the functions, or portions thereof, of the contract management monitoring systems and methods described herein. Applications 180, 181 may cause the system 125 may interface or otherwise connect with contract management systems 128, 168 in order to perform operations in accordance with embodiments of the present disclosure described herein.

### Rule Tracking Module

Embodiments of the present disclosure may include a rule tracking module. The rule tracking module, as part of the computer-implemented system, may be configured to receive information regarding client-specified contract criteria in electronic form. In some instances, the criteria may be provided to the rule tracking module in electronic format as an document, for example, in word-processing format, in portable document format (PDF), or any other electronic format. In other instances, however, criteria may be provided in physical documentary format or even orally, and may need to be entered into the rule tracking module manually by an operator.

Once received into the rule tracking module, the client-specified criteria may be decomposed into individual rules. For example, an individual criteria may need to be broken down into a plurality of individual rules, depending on how complex the criteria is. In one example related to investment management, an investment criteria may include a particular allocation of a portfolio in a particular type of investment instrument. In such case, the associated rule will specify a percentage of such investment instrument that the portfolio is not to exceed. In another example, an investment criteria may include a restriction on investing in a particular industry, for example, the tobacco industry. In this case, several rules may be required based on this single criteria including rules restricting the purchase of bonds for companies within the industry, rules restricting the purchase of equities of companies within the industry, and so forth. The present disclosure is not limited to any particular way in which particular criterion may be decomposed into one or more specific contract rules. Rather, contract rules may be determined considering the complexity of the database with which the rules will interact, and the complexity of the criteria, among other things.

In the computer-implemented system, the rule-tracking module may store in one or more data storage components (for example, a database or mass storage device 140, 160) information regarding the document which the criteria originate, and any rules that are derived from such criteria. When stored in the database, documents including criteria may be associated with the resultant rules, thereby linking the rules to the originating document from which the rules are derived. In this manner, organizations may be more easily able to track the rules to which their contracts are subject, and they may be more easily able to trace the rules to their originating documents. Furthermore, when a contract criterion is updated, as may happen over time, the amendments to the criteria are also in this manner able to be traced to the specific document or file from which the amendment originates. This provides a further level of traceability with regard to the particular rules to which the portfolio is subject.

Again referring to the particular example of investment contract management, the data storage components, in one embodiment, along with each individual rule, may store an indication of the particular investment portfolio or client with which a rule is associated. As will be appreciated, the investor may intend any given investment criteria to apply to a particular portfolio, or alternatively, all of the portfolios that are owned by that client. Where an investment criterion, from which rules are derived, is applicable only to a portfolio, the rule-tracking module may store an indication of that portfolio in the data storage component along with the rules that derived from that criterion. Alternatively, where the investment criterion pertains to all of the client investor's portfolio, an indication of the client may be stored by the rule-tracking module in the data storage components along with each such rule.

By deconstructing each contract criterion into individual rules, and then associating each of the rules with the originating documents that provide the criteria from which such rules derive, the organization is able to audit and trace each of the rules that is being applied. Furthermore, in this manner, the rule tracking module may provide a consistent understanding of the rules that are to be applied across all contracts of a client where similar criteria are set forth, such that all interested parties can easily track the application, derivation, and applicability of each rule.

### Rule Priority Module

Embodiments of the present disclosure may include a rule priority module. The rule priority module, as part of the computer-implemented system, may be configured to assign a subjective risk level to a particular rule. Risk levels may be assigned to a given rule based on an understanding of the importance of that rule to the performance of the contract. For example, a rule, the violation of which would also be a violation of a legal requirement, may be assigned a relatively higher risk level than a rule that is based on a particular philosophy or other secondary consideration. In one embodiment, the subjective risk levels that may be assigned to a given rule include “high,” “medium,” and “low.” Although, it will be appreciated that any other subjective indication of risk level will be suitable for use in present disclosure, as well as fewer or greater risk levels.

Where a plurality of rules are applicable to a contract, rules may be grouped into functions. Functions may include a set of two or more rules. While any rules may be grouped together in a function, in some embodiments, rules may be grouped into functions based on similarity or dependency. For example, using the example of an investment management contract, all rules that relate to investing in a particular industry may be grouped into a single function. Likewise, all rules that relate to a particular legal requirement may be grouped into another function. Other functions may be created in a similar manner. There is no limitation on the number of rules that may be included in function.

Just as with rules, functions may be assigned a subjective risk level. In one embodiment, a function may be assigned a risk level independently of the rules that comprise the function. In this manner, a party to the contract can make a subjective evaluation of the function, and assign a risk level to it. In another embodiment, the risk level of a function may be based on the risk levels of the rules that comprise the function. For example, for a function that has all or most of its constituent rules rated as high, the rating of that function may be relatively higher than a function that has all or most of its constituent rules rated as low.

Furthermore, in some embodiments, where an investment management contract is involved, the market value of a portfolio or series of portfolios to which the rules of a function apply may be used to determine the risk rating of the function. For example, a function applicable to a number of portfolios with a high aggregate market value of assets may have a higher risk level assigned to it than a function that applies to a smaller set of assets measured by market value.

The risk level of a rule or of a function may be stored in the data storage component, associated with its particular rule or function. As such, the risk level forms a part of the information that firm can track and trace with regard to a particular contract criteria.

As will be described in greater detail below with regard to the rule testing module, rule risk level and function risk level assignments may be useful in determining the priority with which rules or functions are tested. For example, rules or functions with a relatively higher risk level may be desirably tested against a portfolio prior to rules or functions with a relatively low risk level. This may be a particular concern where there are numerous rules or functions, and only a limited time in which to test such rules/functions.

### Rule Testing Module

Embodiments of the present disclosure may include a rule-testing module. The rule-testing module, as part of the computer-implemented system, may be configured to determine whether or not a particular rule or function has been applied, i.e., tested, within a specified time frame. With regard to testing, functions may be automated, which indicates that they may be performed automatically by a computerized system. Additionally or alternatively, functions may be manual, which indicates that they may be performed manually by an operator.

Functions may be scheduled to be applied or tested within any desired time frame. For example, functions may be desired to be applied on a periodic basis, for example, daily, weekly, monthly, quarterly, etc. In other embodiments, functions may be desired to be applied on an irregular basis, wherein the timeframe is specified particularly by the client. Functions may themselves be grouped into collections that can be applied all at the same time, thereby reducing the computational workload.

With regard to automated functions, the system of the present disclosure may electronically receive information regarding testing of rules and functions. Such electronic communication may occur, for example, via direct connection, or over a network, such as network 150. With regard to manual functions, the particular testing procedures may be required to be performed by an operator manually, wherein the operator inputs the result of the testing of the rule or function directly into the present system.

In one embodiment, the presently described system may be configured to provide an alert or other notification when the required testing of a function is missing. With regard to automated functions, this may occur where the system receives information that certain functions have been tested within a given timeframe, and wherein a particular function is missing from a listing of completed functions in the received information. For example, where five functions are to be tested within a given timeframe, and the system receives electronic information that only four functions have been tested, the system may provide an alert notification with regard to the missing fifth function test. With regard to manual functions, the system may provide an alert or notification where it fails to receive data input from an operator that a particular function has been completed within the specified time frame. The presently described system may also be configured receive and store in the data storage component information regarding the results of such testing, i.e., whether a test has been passed or failed. Where a test is failed, the organization may be provided with information with regard to the manner in which the performance of the contract is out of compliance with the stated criteria, and can thus follow-up with the party charged with performance to take corrective action.

As discussed above, where many functions are to be applied within a short timeframe, it may be useful to prioritize the testing of functions based on the relative risk level of such functions. For example, an organization would likely consider it to be more important that, given limited capacity, a rule or function relating to a legal requirement is tested prior to a rule or function relating to a philosophy or other secondary consideration. In this manner, the presently described system may use the subjective risk level, discussed above, to “triage” functions where only a limited number of functions may be applied within a specified time frame. In this manner, although the system may still be configured to issue alerts for the missing function tests, the system will have prioritized functions that have a higher risk level for testing.

In further embodiments, alerts or notifications may also be provided where a rule or function test has been changed, deleted, inactivated, or disassociated. In this manner, the system may provide continued surveillance and auditing of the required tests to ensure compliance with the contract criteria, where any changes to such testing are duly transmitted by notification to the client.

### Computerized System Interface

As discussed above, certain modules of the presently described system may require an operative electronic interface with one or more computerized systems. FIG. 1, discussed above, shows an example embodiment of a system in accordance with the present disclosure with a direct electronic connection to a first computerized system 128, and a network connection to a second computerized system 168. Electronic data may be sent to and received from the computerized system in this manner. For example, rule and function information may be sent from the rule-tracking module, discussed above, to the computerized system. In another example, testing information may be sent from the computerized system to the rule-tracking module, discussed above.

### User Interface

As described herein, the client investor can provide one or more contract criteria in electronic or documentary format for use in testing to ensure compliance with the stated criteria. The presently described system may allow the client investor electronic access to the status of the performance of the contract, including the status and completion of the required tests of rules and functions. To ensure ease of access for the client to this information, the presently described system may provide an electronic client interface for use by the client to view the status of their contract, as desired.

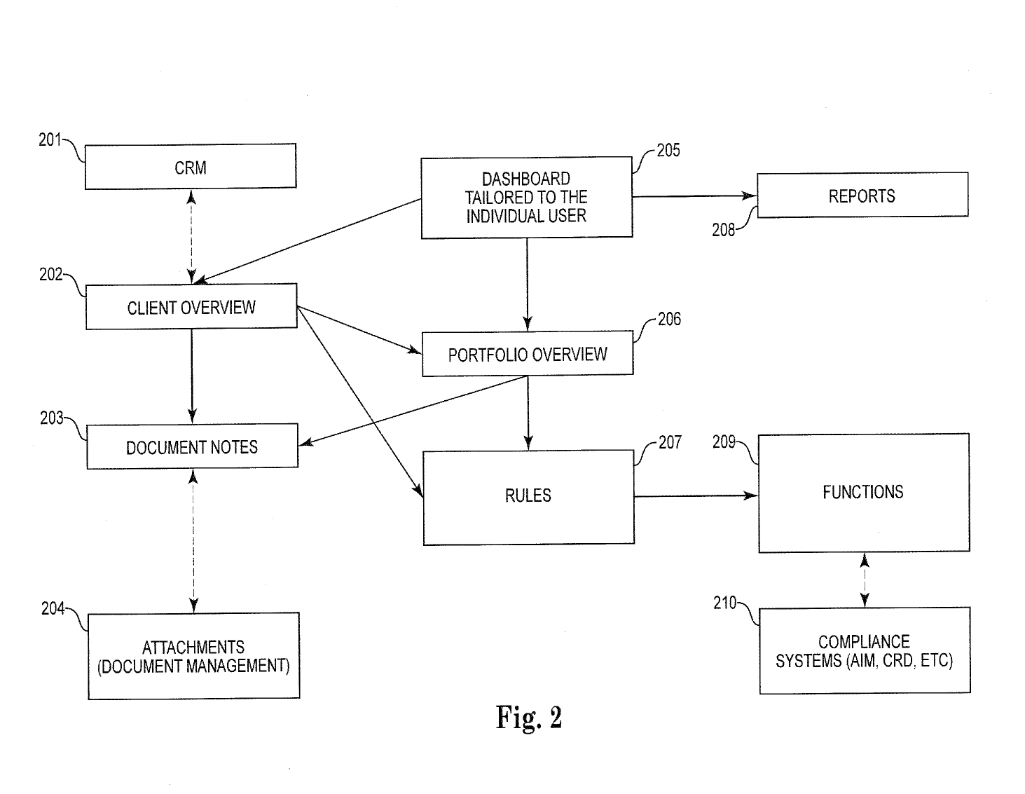

As shown in FIG. 2, in one aspect, the interface can provide a client overview page 202 that may include a dashboard 205 that is tailored to the individual user. The dashboard may be a interface module that allows a user to monitor the contract, rules, functions, etc., and to provide or revise criteria, as desired. The client overview page 202 may further be linked to customer relationship management modules (201), that allow the operator of the presently described system to actively interact with the customer relationship team to take care of any problems or concerns they may have with the operation of the system.

With regard to the client-specified criteria, the client overview page 202 may provide the ability to access any notes 203 provided in connection with such criteria. The notes 203 may be linked to the original criteria containing documents (electronic or physical, as discussed above) in the form, for example, of attachments 204.

The dashboard 205 or client overview page 202 may provide the user access to a portfolio overview 206, where the user can view the a portfolio that may be associated with the contract, for example, as may be applicable to the case of investment management contracts. The portfolio overview 206 may, in turn, be linked to the rules 207 and the functions 209 that are to be tested within the client-specified time frame. For automated functions, there may be a link to the computerized system 210 of the party in charge of the performance of the contract.

In a further aspect of the presently disclosed system, the dashboard 205 may allow the user to prepare and print a variety of reports 208. These reports may include, but are not limited to, status of rules or functions tests, results of rules or functions tests, and listing of rules and functions, among other things.

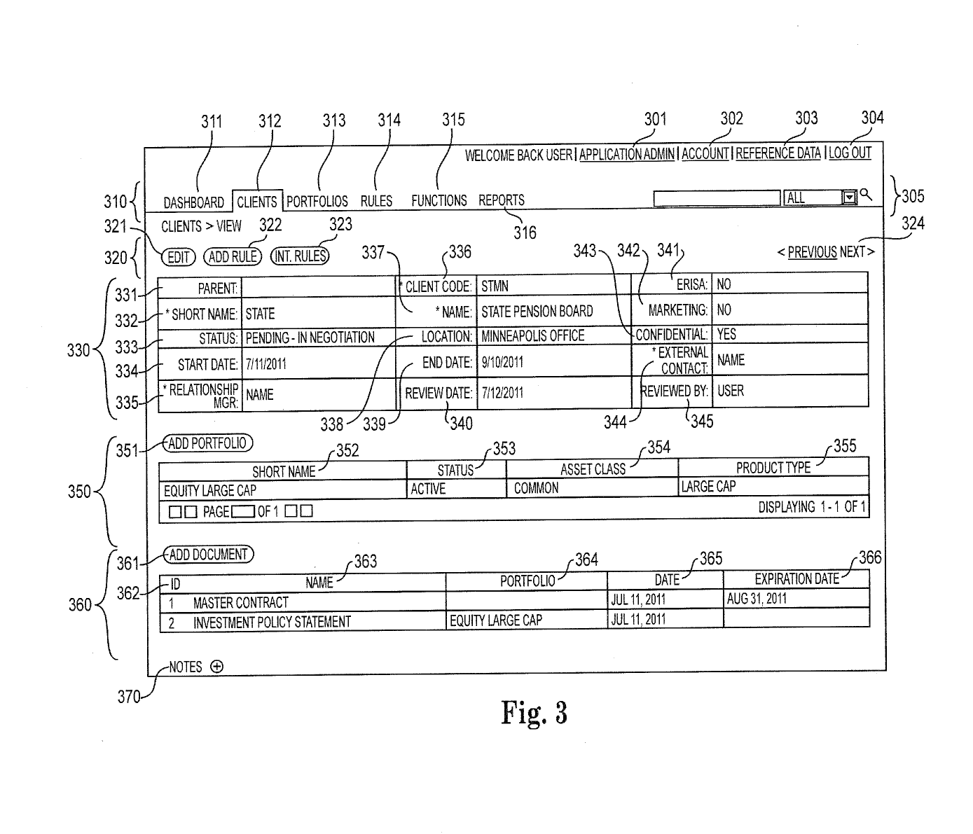

FIGS. 3-6 depict example user interface screens in accordance with one embodiment of the present disclosure. The particular configuration shown is intended to be broadly illustrative of features that may or may not be included in a particular embodiment. More or fewer features may be included, and their arrangement may be altered to suit the needs of a particular user. Furthermore, while those particular examples shown in FIGS. 3-6 are directed to investment management contracts, it will be appreciated that it is within the level of ordinary skill in the art to modify such screens for use with any type of contract without undue experimentation, and therefore falls within the scope of the present disclosure.

With regard to FIG. 3, a user interface may include a variety of features and links. An application administration link 301 may allow an operator of the system to make changes to the system configuration. An account link 302 may allow the user to select from among two or more accounts. A reference data link 303 may allow the user to access the data fields that comprise the information presented in the client interface. A logout link 304 may bring the user to a screen that logs the user out of the system.

A series of tabs 310 may be provided to allow the user to switch between the various features of the user interface discussed above with regard to FIG. 2. The dashboard tab 311 may bring the user to the dashboard 205. The clients tab 312 may bring the user to the client overview screen 202. The portfolios tab 313 may bring the user to the portfolio overview 206. The rules tab 314 may bring the user to the rules screen 207. The functions tab 315 may bring the user to the functions screen 209. Further, the reports tab 316 may bring the user to the reports screen 208.

A search function 305, included in some embodiments, may allow the user to enter keyword searches to find specific information. A previous/next link feature 324 may allow the user to move back and forth between the various screens sequentially.

With specific reference to the client overview screen shown in FIG. 3 (which may be accessed by selecting the clients tab 312), the screen may include a rule editing function 320. The rule editing function 320 may allow the user to edits rules (321), add rules (322), and integrated rules (323).

The client screen may further include a client information display 330, that may include information pertaining to the client parent entity 331, the client's reference name 332, the client status 333, the client start date 334, the client relationship manager name 335, the client code 336, the full client name 337, the client location 338, the end date of the client portfolio access 339, in any, the next portfolio review date 340, whether the portfolio is an ERISA account 341, marketing information 342, confidentiality status 343, external contact information 344, and reviewer information 345, among other things.

The client screen may further include a portfolio information display 350, that may include the ability to add a portfolio 351, the short name of the portfolio 352, the status of the portfolio 353, the asset class of the portfolio 354, the product type of the portfolio 355. There may be multiple entries for portfolios that have multiple assets/classes.

The client screen may further include a document information display 360 (for criteria containing documents), that may include the ability to add a document 361, document identifier 362, document name 363, portfolio name 364, date of addition 365, and expiration date 366, if any. In some embodiments, the client screen may include the ability to add notes 370 for future reference. Other information may also be included.

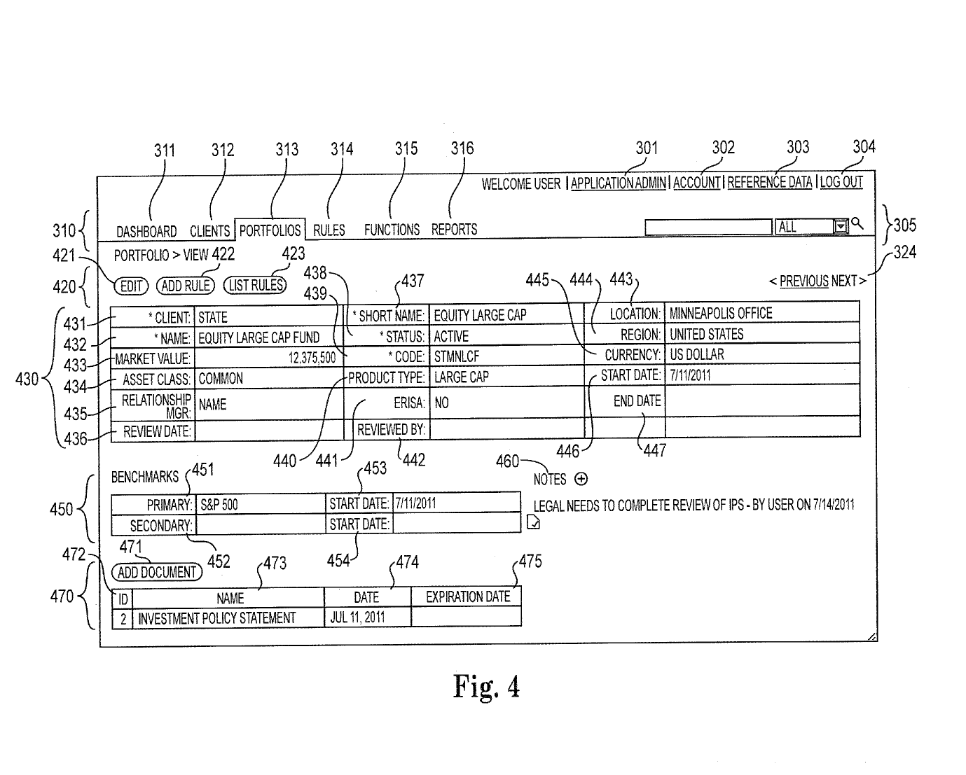

With specific reference to the portfolios overview screen shown in FIG. 4 (which may be accessed by selecting the portfolios tab 313), the screen may include a rule editing function 420. The rule editing function 420 may allow the user to edits rules (421), add rules (422), and list rules (423).

The client screen may further include a portfolio information display 330, that may include information pertaining to the client entity 431, the portfolio's reference name 432, the market value of the portfolio 433, the portfolio asset class 434, the client relationship manager name 435, the next portfolio review date 436, the abbreviated portfolio name 437, the portfolio status 438, the portfolio code 439, the portfolio product type 440, whether the portfolio is an ERISA account 441, the reviewer information 442, the client location 443, the client region 444, the portfolio currency 445, the portfolio start date 446, and the portfolio end date 447, if any, among other things.

The portfolio screen may further include a benchmark information display 450, which may include primary benchmarks 451, secondary benchmarks 452, and start dates of each, respectively, 453, 454. A notes feature 460 may be included in some embodiments. An add document feature 470 may include the ability to add a document 471, a document identification 472, a document name 473, a document date 474, and a document expiration date 475, if any. Other information may also be included.

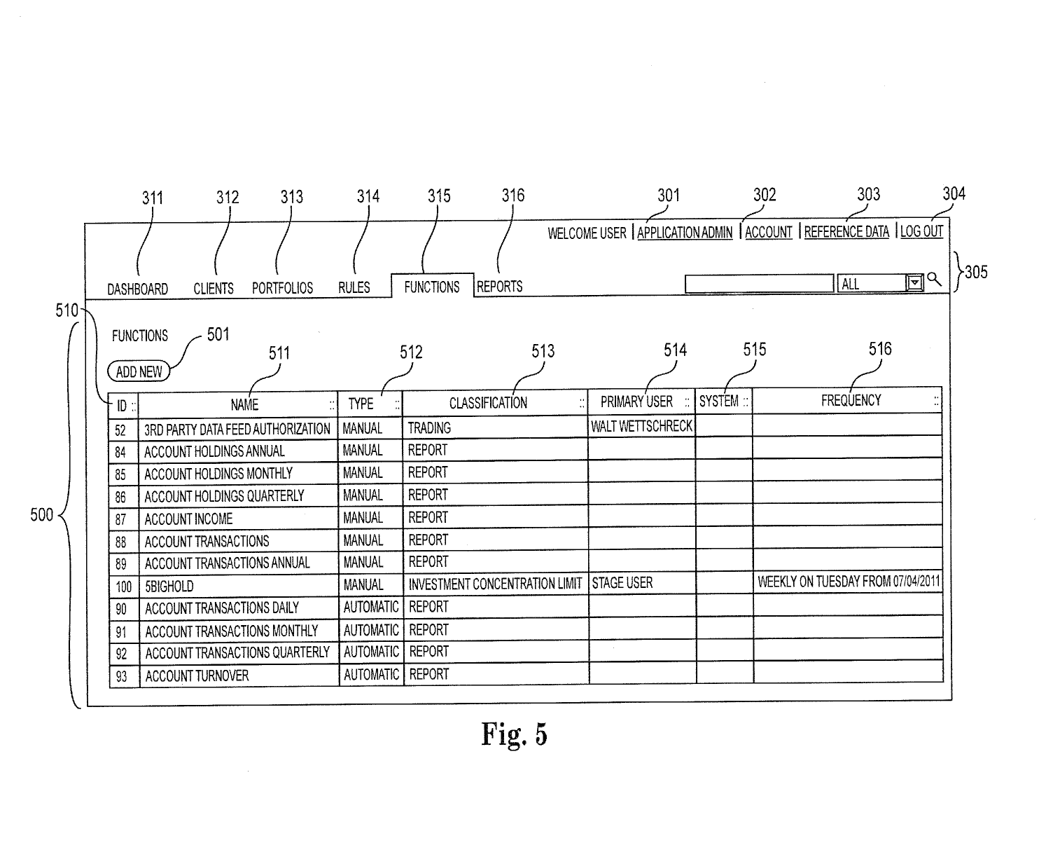

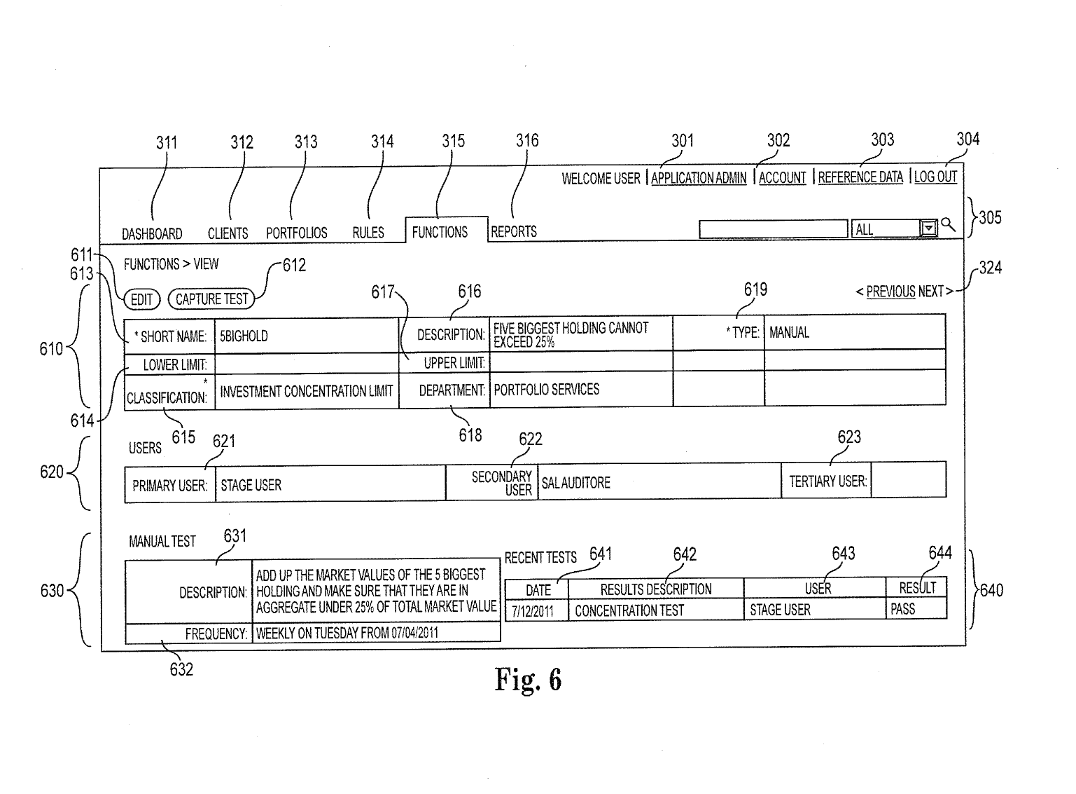

With specific reference to the functions overview screen shown in FIG. 5 (which may be accessed by selecting the functions tab 315), a listing of functions 500 may be provided. The ability to add a new function 501 may also be provided. The listing of functions 500 may include the function identification 510, the function name 511, the function type 512, the function classification 513, the primary user 514, the system name 515, and the function testing frequency 516. Other information may also be included.

Where a particular function is selected from the functions overview screen shown in FIG. 5, a functions view screen, as shown in FIG. 6, may be provided. The functions view screen may include the ability to edit the function 611 and to perform a test capture 612. Function information 610 may be provided thereon. This information may include the short name of the function 613, the lower limit of the function 614, the classification of the function 615, the function description 616, the upper limit 617, the department to which the function is assigned 618, and the type of function (automated, manual) 619.

User information 620 may further be provided on the functions view screen. This information may include the primary user 621, the secondary user 622, and the tertiary user 623. Testing information 630 may also be provided. This information may include test description 631 and test frequency 632. A recent tests information display 640 may provide the results of recent portfolio test. This information may include the date of the test 641, the results description 642, the user 643, and the result of the test 644. Other information may also be included.

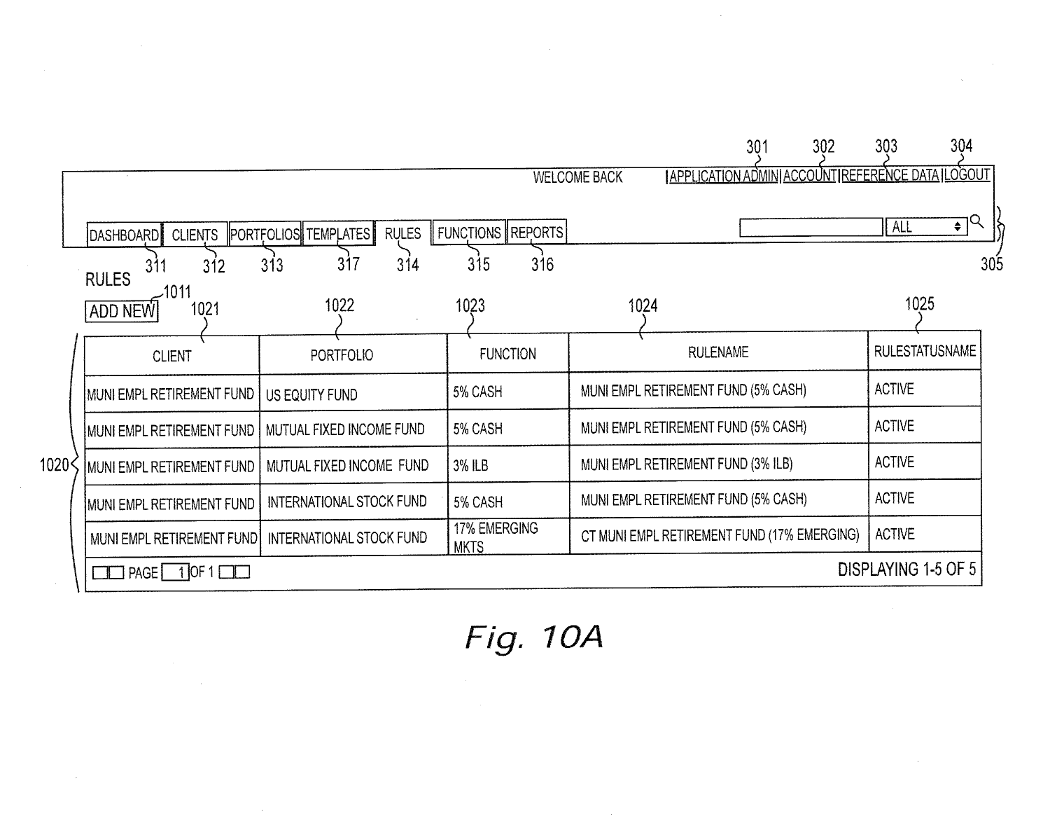

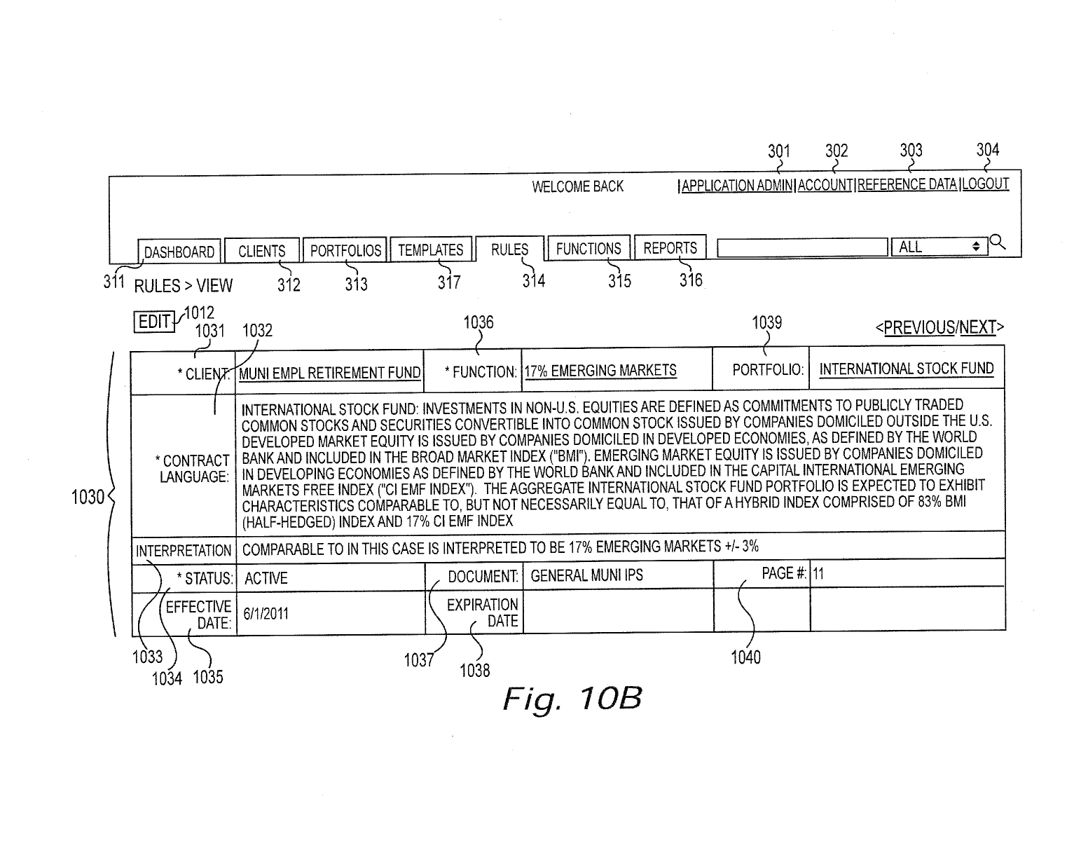

With specific reference to FIGS. 10a and 10b, example rules screens are disclosed. In FIG. 10a, a rules list screen is disclosed having rules list information 1020, which may include client information 1021, portfolio information 1022, function information 1023, rule name information 1024, and rule status name 1025. Rules may be added by selection “Add New” icon 1011, and entering the appropriate information In FIG. 10b, a rules detail screen is disclosed having rules detail information 1030, which may include client information 1031, contract language information 1032, interpretation information 1033, status information 1034, effective date 1035, function information 1036, document information 1037, expiration date 1038, portfolio information 1039, and page number 1040. Rules may be edited by selecting the “Edit” icon 1012, and entering appropriate information.

### Methods of Operation

With respect to the methods described below, it will be appreciated that the accompanying figures are provided merely for illustration. The various blocks or steps may be performed in an order other than that shown. Further, more or fewer blocks or steps may be included than those shown.

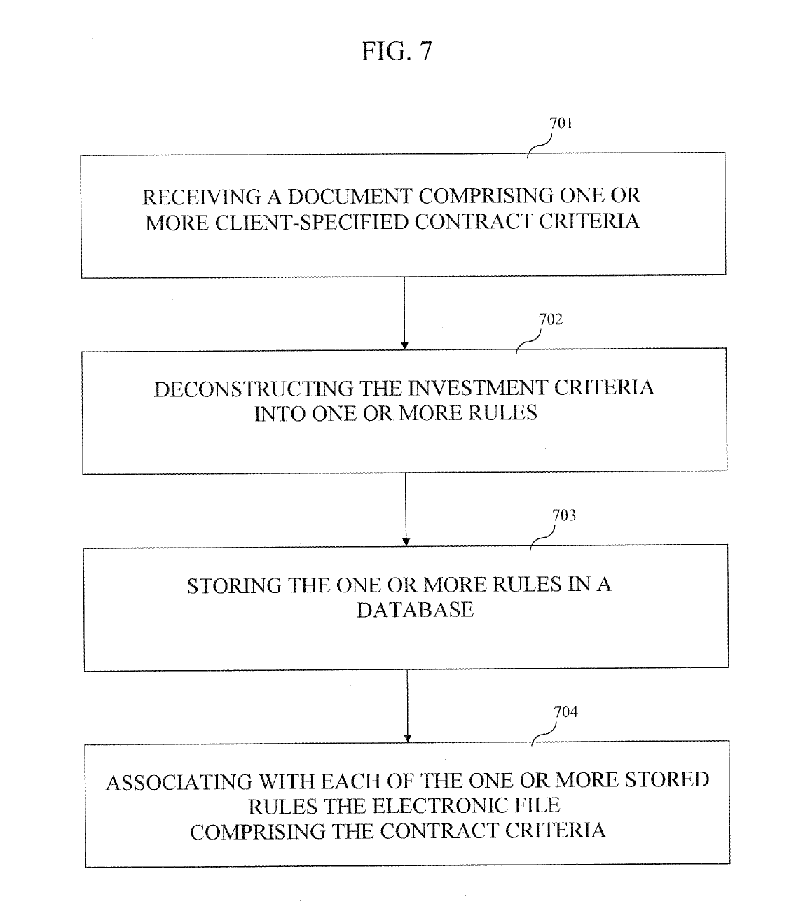

In one embodiment, as shown with respect to FIG. 7, a method in accordance with the present disclosure may include, at block 701, receiving a document comprising one or more client-specified criterion. As discussed above, this document may be provided in any electronic document format. Alternatively, it may be provided in physical document format, and converted by an operator to electronic format, or it may remain in physical format. At block 702, the method may include deconstructing the criteria into one or more contract rules and/or functions. As discussed above, the deconstruction process may be based on the complexity of the criteria, the applicability of the criteria, and other considerations. At block 703, the method may include storing the one or more contract rules in a database operatively connected with a computer processor. At block 704, the method may include associating with each of the one or more stored contract rules the document comprising the criteria from which such rule derives. Such association desirably allows for association and traceability of the rule with respect to the document from which such rule derives.

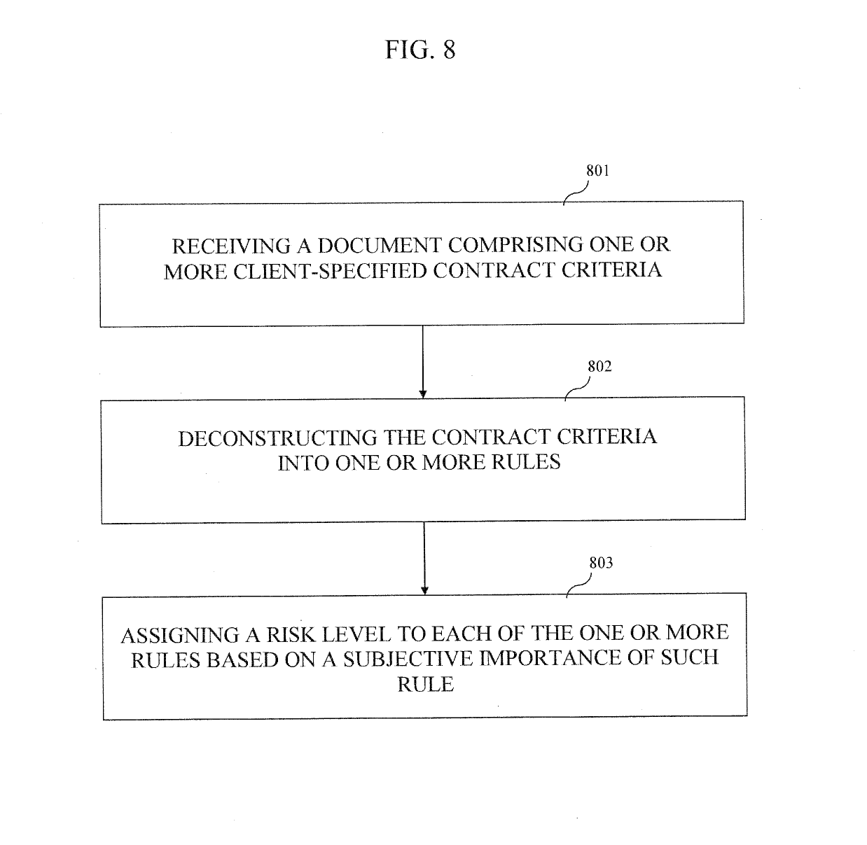

In another embodiment, as shown with respect to FIG. 8, a method in accordance with the present disclosure may include, at block 801, receiving a document comprising one or more client-specified criteria and at block 802 deconstructing the criteria into one or more contract rules and/or functions, as discussed above with regard to blocks 701 and 702. At block 803, the method may further include assigning a risk level to each of the one or more rules based on a subjective importance of such rule. The assigned risk level may allow for prioritization of the testing of rules and functions where there is only a limited amount of time to apply numerous rules.

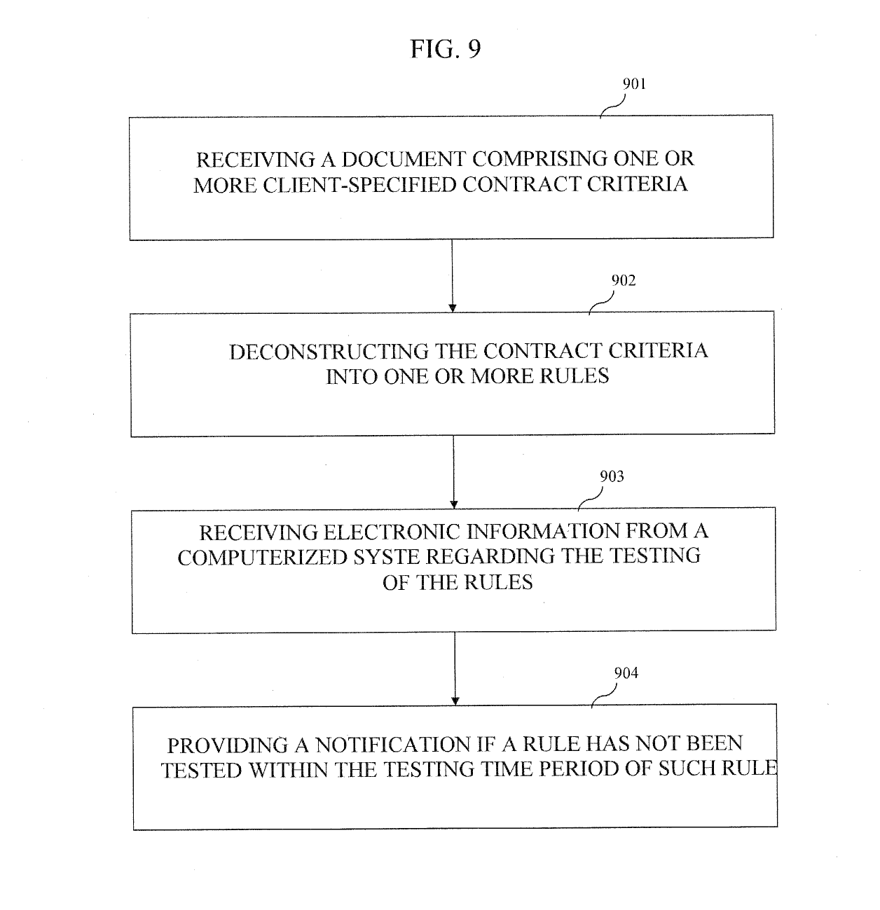

In a further embodiment, as shown with respect to FIG. 9, a method in accordance with the present disclosure may include, at block 901, receiving a document comprising one or more client-specified criteria and at block 902 deconstructing the criteria into one or more contract rules and/or functions, wherein each of the rules comprises a testing time period, as discussed above with regard to blocks 701 and 702. At block 903, the method may include receiving electronic information from a computerized system regarding the testing of rules. This information may be received through an electronic interface. The method, at block 904, may further include providing a notification if a rule has not been tested within the testing time period of such rule. The notification or alert allows the organization to continuously be apprised of the status of the portfolio with respect to the stated criteria, rather than having to wait for a monthly, quarterly statement to determine the compliance of the portfolio. Errors can be more easily and quickly corrected in this manner, and the party charged with performance may be incentivized to maintain a high level of compliance with the client's stated contract criteria.

### Benefits of the Disclosed System and Method

Embodiments of the present disclosure include features that overcome the limitations known in the art. For example, embodiments of the present disclosure may be configured to capture contract criteria and maintain an accurate record of the origin and implementation of such criteria. As such, the client may be able to effectively trace the origin and accuracy of the rules and functions. In another example, embodiments of the present disclosure may be configured to assign a relative importance level to the one or more contract rules to efficiently distinguish between rules of relatively higher importance and rules of relatively lower importance. As such, where there is a limited amount of time to apply numerous rules and functions, the system may be able to distinguish between rules and apply to most important thereof in the available time. In yet another example, embodiments of the present disclosure may be configured to monitor the performance of a computerized system to ensure that all of the required tests are being performed at the required times. The systems of the present disclosure may include a computer-implemented system providing an electronic interface to allow the investor to continuously monitor the performance of the system, to track contract rules, and to ensure that all required tests are being performed. As such, the systems and methods of the present disclosure may provide comprehensive auditing for contract management.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. A computer-implemented method of monitoring compliance with contract criteria, comprising:
receiving a document comprising one or more client-specified contract criteria;
deconstructing the criteria into one or more contract rules;
storing the one or more contract rules in a database operatively connected with a computer processor; and
associating with each of the one or more stored contract rules the document comprising the criteria from which such rule derives.

2. The method of claim 1, further comprising associating with each of the one or more stored contract rules an indication of a portfolio to which such rule pertains.

3. The method of claim 1, further comprising associating with each of the one or more stored contract rules an indication of the client to which such rule pertains.

4. The method of claim 1, wherein the criteria is deconstructed into two or more rules, and wherein at least two of the two or more rules are grouped into a function.

5. The method of claim 4, wherein rules are grouped based on similarity.

6. The method if claim 4, further comprising assigning a risk level to each of the one or more rules based on a subjective importance of such rule.

7. The method of claim 6, wherein the risk level is selected from the group consisting of “high”, “medium”, and “low”.

8. The method of claim 7, wherein a risk level is associated with the criteria, and wherein the risk level assigned to each rule corresponds with the risk level of the criteria from which such rule derives.

9. The method of claim 6, further comprising assigning a risk level to a function based on the individual risk level of each of the two or more rules that comprise the function.

10. The method of claim 9, wherein the risk level of a function is further based on a market value of the subject matter of the contract from which at least one of the two or more rules derives.

11. A computer-implemented method of monitoring compliance with contract criteria, comprising:
receiving a document comprising one or more client-specified criteria;
deconstructing the criteria into one or more contract rules, wherein each of the rules comprises a testing time period;
providing traceability from the document to the computerized contract rules;
receiving electronic information from a computerized system regarding the testing of rules; and
providing a notification if a rule has not been tested within the testing time period of such rule.

12. The method of claim 11, wherein the criteria is deconstructed into two or more rules, and further comprising assigning a risk level to each of the one or more rules based on a subjective importance of such rule.

13. The method of claim 12, wherein at least two of the two or more rules are grouped into a function.

14. The method of claim 13, further comprising assigning a risk level to a function based on the individual risk level of each of the two or more rules that comprise the function.

15. The method of claim 14, wherein rules in a function with a relatively higher risk level are tested against the investment portfolio prior to rules in a function with a relatively lower risk level.

16. A computer-based system for monitoring compliance with contract criteria, comprising:
a data processing component and a data storage component in electronic communication with one another;
a rule-tracking module configured to cause the data processing component to:
receive a document comprising one or more client-specified criteria;
deconstruct the criteria into one or more contract rules and store the contract rules on the data storage component; and
associate with each of the one or more contract rules the document comprising the criteria from which such rule derives;
a rule priority module configured to cause the data processing component to:
assign a risk level to each of the one or more rules based on a subjective importance of such rule; and
a rule-testing module configured to cause the data processing component to:
receive electronic information from a computerized system regarding the testing of rules; and
provide a notification if a rule has not been tested within the testing time period of such rule.

17. The system of claim 16, wherein the rule tracking module is further configured to cause the data processing component to associate with each of the one or more stored contract rules an indication of a portfolio or a client to which such rule pertains.

18. The system of claim 16, wherein the criteria is deconstructed into two or more rules, wherein at least two of the two or more rules are grouped into a function.

19. The system of claim 18, wherein the rule priority module is configured to assign a risk level to a function based on the individual risk level of each of the two or more rules that comprise the function.

20. The system of claim 19, wherein rules in a function with a relatively higher risk level are tested prior to rules in a function with a relatively lower risk level.
